(19) United States
(12) Patent Application Publication
(10) Pub. No.: US 2009/0002438 A1
(43) Pub. Date: Jan. 1, 2009

(54) Separator

(75) Inventors: Ziv Raz, Even Yuhooda (IL); Gabriel Rosen, Herzlia (IL)

Correspondence Address: Hewlett-Packard Company, Intellectual Property Administration, P.O. Box 272400, Ft. Collins, CO, 80527-2400, US

(73) Assignee: HEWLETT-PACKARD DEVELOPMENT COMPANY, L.P., Houston, TX (US)

(21) Appl. No.: 11/769,828

(22) Filed: Jun. 28, 2007

(51) Int. Cl. B41J 2/165; B41J 2/175

(52) U.S. Cl. 347/35; 347/93

(57) ABSTRACT

A separator for separating ink from a flow of gas and ink, the separator comprising a container containing a plurality of material bodies, the container having: an inlet for flowing a mixture of gas and ink into the container so that the gas and ink passes through interstices between at least some of the plurality of material bodies thereby separating ink from the mixture of gas and ink; and a gas outlet for removing gas from the container after ink has been separated from the mixture of gas and ink.

Embodiments of the invention are provided as set out in the appended claims and for which protection is sought. Other embodiments of the invention may include embodiments as set out in the following statements:

A printer comprising at least one printhead, a pressure source for providing a flow of ink through the printhead for cleaning the printhead and a separator for separating ink from a mixture of gas and ink produced when the pressure source is used to clean the printhead, the separator comprising: a chamber containing a bed of pieces of material; an inlet for the mixture of gas and ink to enter the chamber so that the flow passes through the bed of pieces of material; and a gas outlet for removing gas from the chamber after the mixture of gas and ink has passed through the bed of pieces of material.

A separator for separating ink from a flow of gas and ink, the separator comprising a container containing a plurality of material bodies, the container having: an inlet for flowing a mixture of gas and ink into the container so that the gas and ink passes through interstices between at least some of the plurality of material bodies thereby separating ink from the mixture of gas and ink; and a gas outlet for removing gas from the container after ink has been separated from the mixture of gas and ink.

A service station for servicing a printhead comprising:
a separator for separating ink from a flow of gas and ink produced when the printhead is purged, the separator comprising: a chamber containing a bed of pieces of material; an inlet for the flow of gas and ink to enter the chamber so that the flow passes through the bed of pieces of material; a gas outlet for removing gas from the chamber after the flow of gas and ink has passed through the bed of pieces of material; and
a gas pump in fluid connection with the gas outlet for removing gas from the chamber.

A method of cleaning/purging a printhead and/or ink conduit comprising: purging ink from the printhead and/or the ink conduits to produce a flow of gas and ink; passing the flow of gas and ink into a container containing a bed of material bodies so that the flow encounters the bed of material bodies and ink is separated from the flow of gas and ink; and removing gas from the container after the gas has been passed through the bed of material bodies.

A method of producing a printed product comprising cleaning the printhead of a printer by performing a purging routine and then printing on a product using the printer, wherein the purging routine comprises: purging ink from the printhead to produce a flow of gas and ink; passing the flow of gas and ink into a container containing a bed of material bodies so that the flow encounters the bed of material bodies and ink is separated from the flow of gas and ink; and removing gas from the container via a gas outlet after the gas has been passed through the bed of material bodies.

A method of separating ink from a flow of gas and ink comprising passing the mixture of gas and ink through a bed of material bodies so that the ink wets the surface of at least some of the material bodies, thereby removing ink from the flow of gas and ink as the flow passes through the bed.

A method of purging a printhead comprising passing a purging fluid through the printhead, after the purging fluid has passed through the printhead, entraining the purging liquid in a flow of gas, passing this flow of gas and purging fluid through a bed of material bodies such that the purging fluid wets at least a portion of the bed of material bodies and separates out from the flow of gas.

Separator means for separating ink from a flow of gas and ink, the separator means comprising a container means for containing a plurality of material body means, the container means having: an inlet means for flowing a mixture of gas and ink into the container means so that the gas and ink passes through interstices between at least some of the plurality of material body means thereby separating ink from the mixture of gas and ink; and an outlet means for removing gas from the container means after ink has been separated from the mixture of gas and ink.

Features and embodiments of the invention herein described and/or claimed in a particular category, e.g. as a printer, separator, service station, method, and product by process etc. should also be taken to be disclosed in the other categories. By way of illustrative example, if according to an embodiment of the invention, a separator is defined as having an internal wall then it should be taken that a printer housing such a separator is also an embodiment of the invention and a process of printing a product that uses such a separator is also an embodiment of the invention and so forth.

Embodiments of the invention are herein described, by way of non-limiting example only, with reference to the accompanying drawings, wherein:

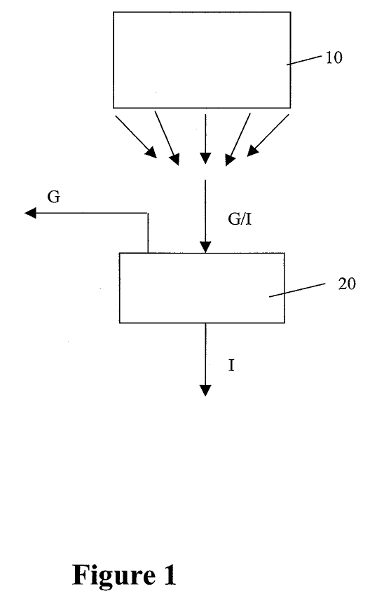

FIG. 1 is a schematic illustration of a system according to an embodiment of the invention;

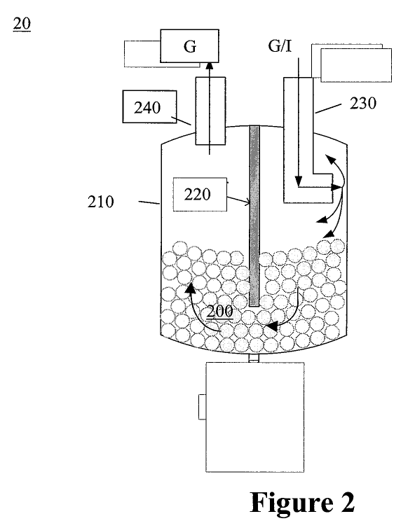

FIG. 2 is a schematic illustration of a separator according to an embodiment of the invention;

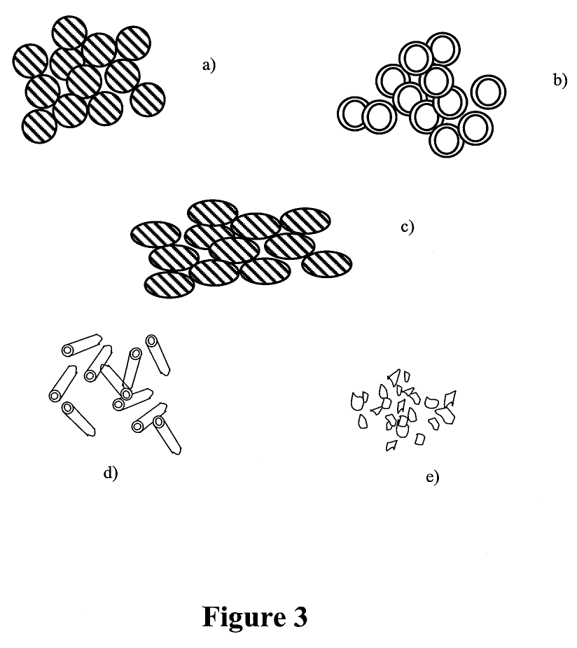

FIG. 3 is a schematic illustration of pieces of material that may be used in a separator according to an embodiment of the invention;

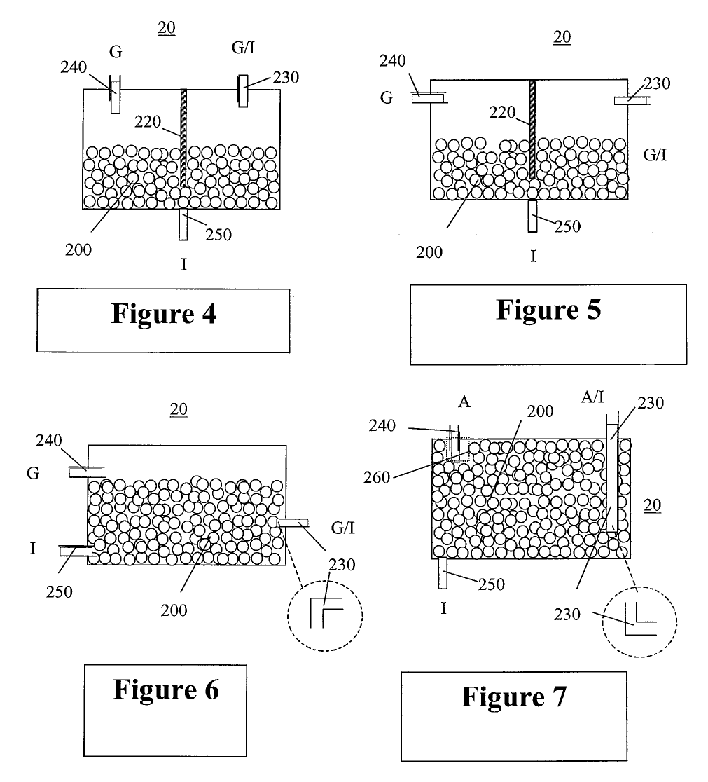

FIG. 4 is a schematic illustration of a separator according to one embodiment of the invention;

FIG. 5 is a schematic illustration of a separator according to another embodiment of the invention;

FIG. 6 is a schematic illustration of a separator according to another embodiment of the invention;

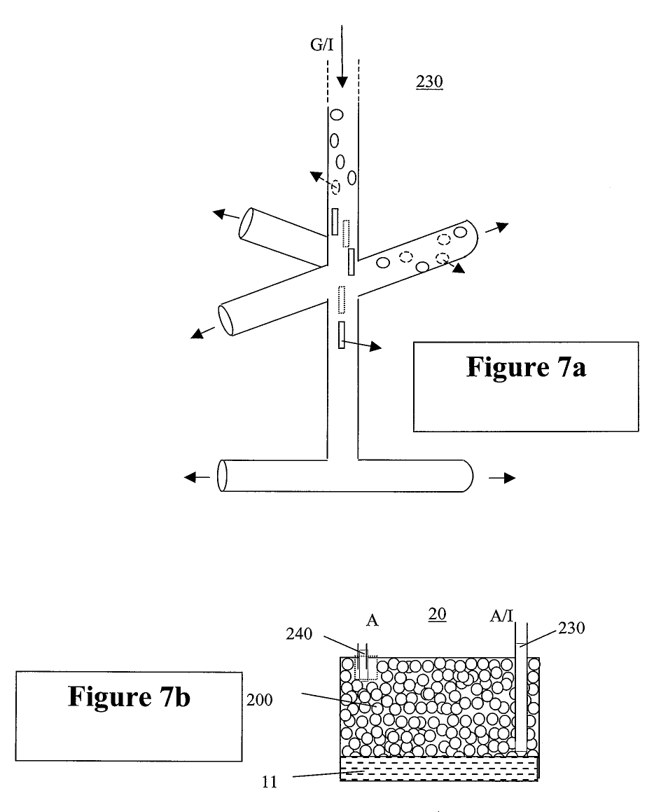

FIG. 7 is a schematic illustration of a separator according to another embodiment of the invention;

FIG. 7a is a schematic illustration of a separator inlet according to another embodiment of the invention;

FIG. 7b is a schematic illustration of a separator according to another embodiment of the invention;

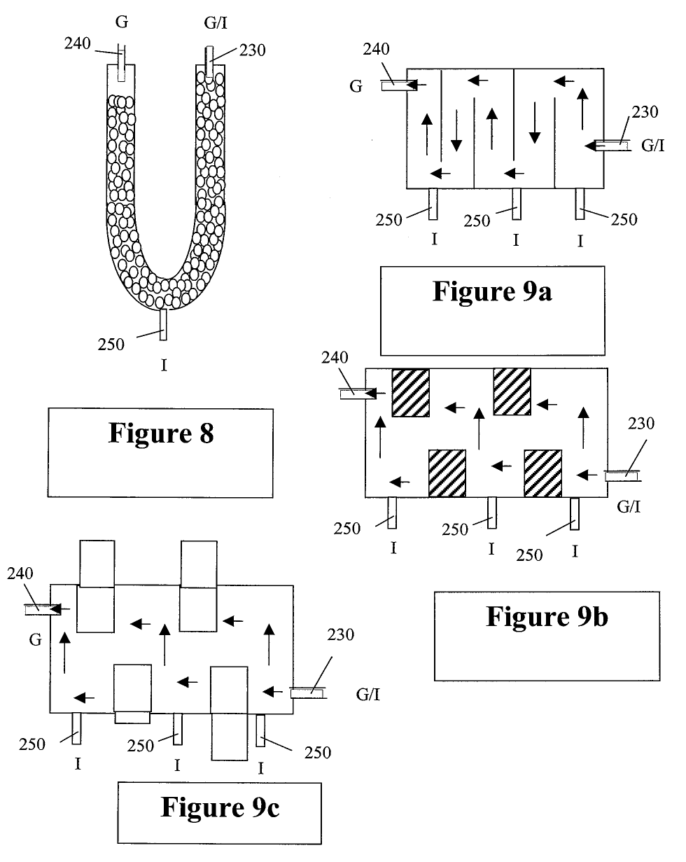

FIG. 8 is a schematic illustration of a separator according to another embodiment of the invention;

FIG. 9a is a schematic illustration of a separator according to an embodiment of the invention;

FIG. 9b is a schematic illustration of another separator according to an embodiment of the invention;

FIG. 9c is a schematic illustration of another separator according to an embodiment of the invention;

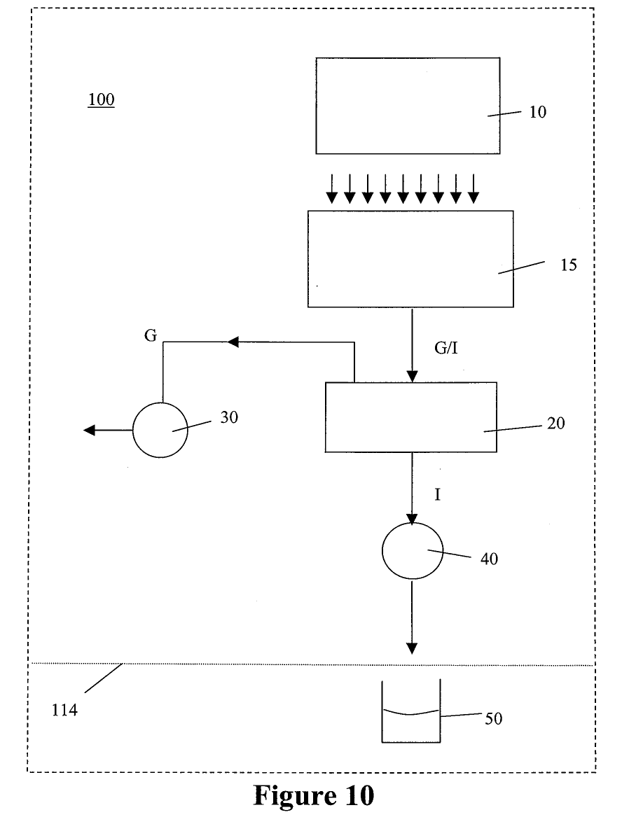

FIG. 10 is a schematic illustration of a printer according to an embodiment of the invention;

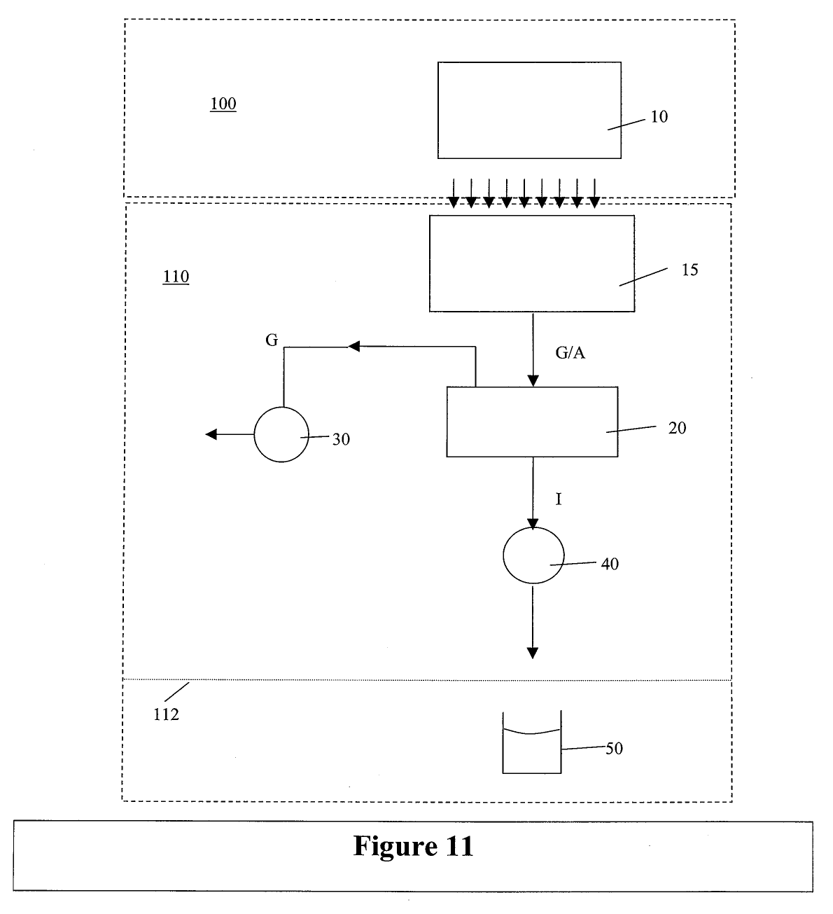

FIG. 11 is a schematic illustration of a printer and a service station according to an embodiment of the invention;

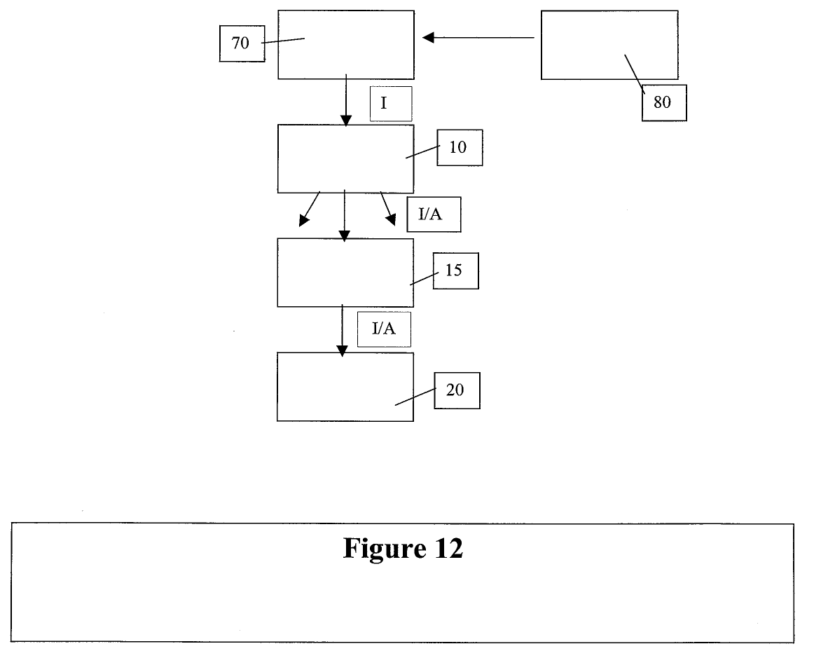

FIG. 12 is a schematic illustration of a purging system according to an embodiment of the invention;

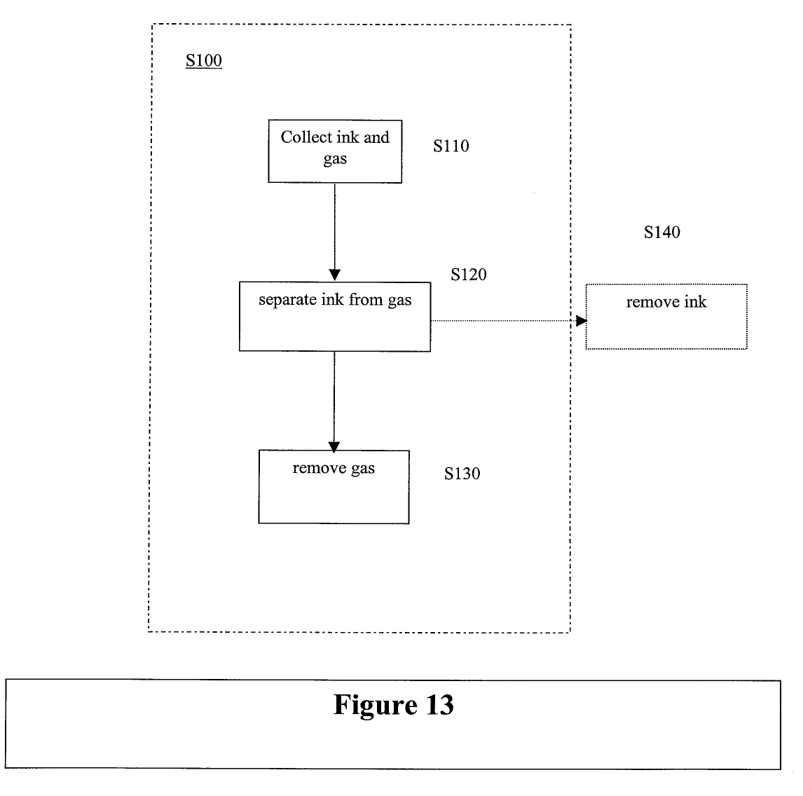

FIG. 13 is a flow diagram of a cleaning process according to an embodiment of the invention; and

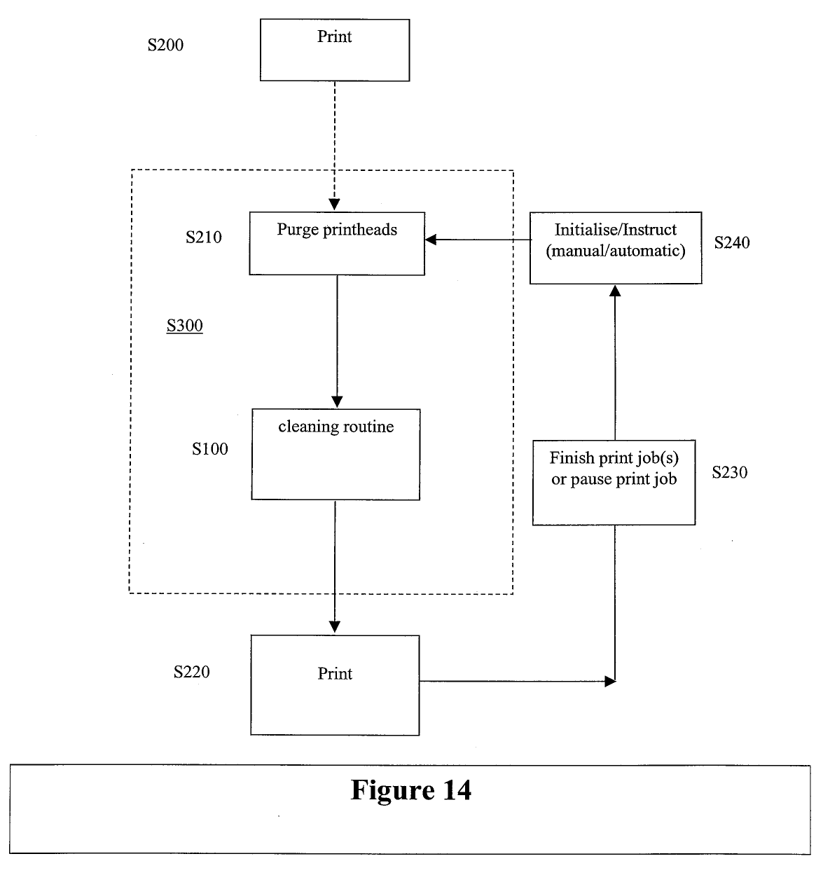

FIG. 14 is a flow diagram of a printing process according to an embodiment of the invention.

The quality of print produced by a printer can depended to a large extent on the condition of the printer's printhead. In particular ink deposits, dust, paper and fabric lint and may reside on the printhead all of which act to degrade the quality of the print. For example, in an ink-jet printer droplets of ink may form on the printhead.

Referring to FIG. 1, according to an embodiment of the invention, ink is drawn a printhead 10 in a flow of gas and ink (G/I) which then enters a separator 20. The separator 20 removes ink (I) from the flow of gas and ink and the gas (G) is exhausted or otherwise removed from the separator 20. In this way the separator 20 may be considered to clean the flow of gas and ink. The cleaned gas may then be vented. The cleaned gas flow may have significantly less ink entrained in it compared to the flow that enters the separator 20 and in some cases the majority or substantially all of the ink may be removed from the gas flow.

In some embodiments of the invention there are multiple printheads 10. For example, some large format printers have arrays containing 200-400 printheads.

Referring to FIG. 2, according to an embodiment of the invention, a separator 20 is illustrated comprising a chamber 210 having an inlet 230 for receiving a flow of gas and ink, a plurality of bodies 200 and a gas outlet 240 for removing gas from the chamber 210 after the flow of gas and ink has passed through interstices between the plurality of bodies 200.

The plurality of bodies 200 provide surfaces that can be wetted by the flow of gas and ink as the gas and ink passes through the interstices between the bodies 210. In this way ink is separated from the flow so that the gas continues through the chamber 210 and the ink drains toward the bottom of the chamber 210.

The plurality of bodies 200 may take many different forms. The purpose of the plurality of bodies 200 is to provide a large surface area on to which the ink in the flow of gas and ink can interacts. For example the ink may form droplets on or spread onto the material bodies. In general this occurs because liquids are more cohesive than gases and it is energetically more favourable for the ink to form on the surfaces of the plurality of bodies 200 than to remain entrained in the flow of gas.

A large surface area can be made available by providing a bed of pieces of material. The pieces of material are not restricted to a particular type of material and the material can be any of a range of material that is able to withstand an ink environment. By way of example only, the material may be chosen to be one of i) glass; (ii) marble (iii) ceramic; (iv) polymeric material (eg plastic) (vi) metallic material; vii) metal alloy such as stainless steel; and viii) any combination of i) to vii). The actual material used may be chosen according to cost considerations and to the degree of wettability of the material. The term “wettability” is the relative degree to which a fluid will spread to coat a solid surface. It may be that the weight of the separator 20 is an important consideration and, in this case, a light material may be chosen. In other cases a highly efficient bed of pieces of material 200 is needed (for example if the volume that the separator 20 can take is restricted) and material that has a high degree of wettability would be beneficial. Stainless steel is an example of a material that has high wettability.

FIG. 3 illustrates some examples of the form that the pieces of material could take. FIG. 3a illustrates spheres of material, or bodies of material that are substantially spherical, that may be chosen so that each material body has a high surface area to volume ratio. As shown in FIG. 3b the bodies may be hollow so as to reduce the weight of a bed 200 of such bodies. The bodies need not be spherical and ovoid bodies, as shown in FIG. 3c would also provide a high surface area to volume ratio for each body. FIG. 3d illustrates an example in which the pieces of material are hollow cylinders so that the flow of gas and ink may flow both between the interstices between the cylinders and through the hollows in the cylinders to provide an increased surface area on to which the ink may spread. It should be appreciated that the shape of the pieces of material is not critical and FIG. 3e illustrates pieces of material having random or arbitrary shapes, as, for example, may be found by having a bed of chips of material. The bed of material pieces 200 may contain a mixture pieces that may be of different material and/or different forms. Because the type of material and the form of the pieces of material is not critical then a bed of material pieces can be obtained that is functional, cheap and readily obtainable.

The use of a bed of pieces of material 200 has the added advantage that it can be used to trap lint, dried ink and other debris that may be entrained in the flow of gas and ink that enters the separator 20.

In some embodiments of the invention the ink that is removed from the flow of gas and ink may be removed from the separator 20 for example by draining the separator 20. This can be done by using gravity or by applying a vacuum to the separator 20. In some embodiments the separator 20 is provided with an ink outlet 250 (as illustrated in FIGS. 4 to 7 for example) so that the ink can be removed from the separator 20. The separated ink collects at the bottom of the chamber 210 under the influence of gravity, therefore the ink outlet 250 is generally provided at the bottom, or close to the bottom, of the chamber 210 so that the ink may be more easily removed. The gas outlet 240 is usually situated above the ink outlet 250 so that the separated ink does not exit the chamber 210 via the gas outlet 240.

The ink may be removed via the ink outlet 250 periodically either automatically or by manual activation. For example, ink may be removed whilst a cleaning operation is being performed, eg simultaneously with the flow of gas and ink being pulled into the chamber 210 from the printheads 10. In other examples the ink may be removed after the cleaning operation has been performed (eg immediately after, substantially immediately after, within a few minutes, or within a few tens of minutes of the clean operation being performed), or at set time intervals (eg hourly, daily, weekly or whatever is appropriate for the printhead usage). The ink in the chamber 210 may be emptied, either automatically or by manual activation, when the ink reaches a certain level in the chamber 210. The level of the ink may be indicated by an indicator such as warning light, a gauge, or other visible indicator or by an audible warning or the indicator may merely comprise a viewing window in the chamber 210 to allow the level of the ink in the chamber 210 to be monitored.

In some embodiments of the invention ink is removed from the chamber 210 before the clean operation is performed (either automatically or manually). This may be done to remove any ink residing in the chamber from a previous clean operation or a plurality of previous clean operations. In one example when a clean operation is initiated an ink drainage operation

In some embodiments the separator 20 does not have a dedicated ink outlet 250. For example, it could be envisaged that, after one or more cleaning operations have been performed, the separator 20 be inverted so that the separated ink can be removed from the chamber 210 via, for example, the gas outlet 240 and/or the gas and air inlet 230. A vacuum may be applied to the gas outlet 240 and/or the gas and air inlet 230, with or without inversion of the separator 20, so as to suck ink out of the separator chamber 210. The gas outlet 240 and/or the gas and air inlet 230 can be utilised for ink removal in this way by, for example, disconnecting the gas outlet 240 and/or the gas and air inlet 230 as appropriate so that separated ink does not enter undesirable places—such as back into the printhead 10 that would otherwise be in fluid connection with the inlet 230 and or into a gas pump that may otherwise be in fluid connection with the gas outlet 240. Similarly a valve, operating on the gas outlet 240 and/or the gas and air inlet 230, could be activated to prevent ink entering undesirable places.

In some embodiments of the invention the ink may remain in the separator 20. For example, when the separator 20 is full or the ink reaches a certain level in the separator 20, or the separator 20 has been used for a certain period of time or for a specified number of clean operations, the separator 20 may be removed from the cleaning system. Since the materials used in the manufacture of the separator 20 may be chosen to be relatively cheap then it is economically feasible that the removed separator 20 be discarded or processed in some way. Alternatively the separator 20 may be cleaned, eg at a site remote from the printer, so that the separator 20 can be reused. The use of a separator 20 in this way is advantageous since it avoids any health and safety or housekeeping issues that may be presented by the handling of the ink at the printing site. In one scenario a contractor could be employed to remove the used separators 20 from the printing site for disposal or reprocessing.

Referring to FIG. 7b, according to an embodiment of the invention, the separator 20 may be provided with an absorber for absorbing ink that has been separated from the flow of gas and ink entering the separator chamber 210. The absorber 11 may take the form of a sponge (for example a foam sponge), a desiccant (eg silica gel) or other suitable material. If used, the desiccant, depending on its form, may be contained in packets or bags inside the chamber 210. In other cases the sponge or desiccant or other material forms a bed. Generally the absorber 11 is situated generally toward or, substantially at, the bottom of the chamber 210 although other configurations may be considered (for example, the absorber 11 may be placed within the bed of pieces of material 200, eg one or more sponge bodies may be present in the bed of pieces of material 200). At appropriate occasions (for example at the times described hereinabove in relation to ink drainage from the chamber 210) the absorber 11 containing absorbed ink may be removed from the chamber 210 and replaced with another absorber 11. In some cases the absorber 11 may be removed from the chamber 20 and ink removed from absorber 11 (e.g., if the absorber 11 is a sponge, by squeezing the sponge) and the absorber 11 placed back into the chamber 210 or into the chamber 210 of a different separator 20. In some embodiments of the invention the absorber 11 is not removed from the separator 20 and the separator 20 is sent for disposal or reprocessing when the absorber 11 becomes saturated, or approaches saturation, with ink. The use of a separator 20 with an absorber 11 does not preclude the separator from having an ink outlet 250.

The gas and ink inlet 230 illustrated in FIG. 2 is shown as a conduit (for example a pipe) that is bent so that the flow of gas and ink is directed at the inside of a wall of the chamber 210. This configuration may be used to help to dissipate the flow of gas and ink so that the flow of gas and ink will pass through a larger volume of the bed of pieces of material 200. Also, by directing the flow of gas and ink at a wall of the chamber 210 some of the ink from the flow wets the wall so that some of the ink separates out from the flow before the flow reaches the bed of pieces of material 200. It should be appreciated that the inlet 230 may take other configurations, for example, the inlet 230 may be a conduit that is bent so that the flow of gas and ink is directed at an internal wall 220. In the separator 20 illustrated in FIG. 2 the internal wall 220 divides the chamber 210.

FIG. 4 illustrates an embodiment of the separator 20 in which the inlet 230 directs the flow of gas and ink downwards onto the bed of pieces of material 200. FIG. 5 illustrates an embodiment of the separator 20 in which the inlet 230 is a conduit in a sidewall of the chamber 200 that is directed at an internal wall 220. In other variations the inlet 230 may be formed from a plurality of nozzles, inlets or tubes or conduits. FIGS. 6 and 7 contain details (represented by a dashed circle) of other variations of the inlet 230. These variations may also be used with the separators illustrated in FIGS. 4 and 5. For example, the inlet 230 may direct the flow upwards, downwards or sideways or in a combination of these directions as appropriate. The design of the inlet 230 is generally chosen so that the flow of gas and ink encounters a large volume of the bed of pieces of material 200.

In some embodiments of the invention the inlet 230 takes the form of a tube that has a number of slots, apertures and/or secondary tubes that are distributed longitudinally and/or radially along the tube so that the inlet 230 is able to direct the flow of gas and ink to different parts of the bed of pieces of material 200. FIG. 7a illustrates an inlet tube 230 having various slots, apertures and/or secondary tubes that may be used either in isolation or in various combinations.

In some embodiments the separator 20 contains one or more internal barriers. For example the separators 20 illustrated in FIGS. 2, 4 and 5 have a barrier in the form of an internal wall 220, between the side of the chamber 210 having the gas and ink inlet 230 and the side of the chamber 210 having the gas outlet 240. The internal wall 220 does not need to be vertical and other orientations can be envisaged. The purpose of the barrier is to direct the flow of gas and ink through the bed of pieces of material 200. That is, the barrier prevents, substantially prevents or hinders the flow of gas and ink from flowing from the inlet 230 to the gas outlet 240 without going through the bed of pieces of material 200.

Referring to FIG. 6, an embodiment of the separator 20 is illustrated in which there is no internal wall between the inlet 230 and the gas outlet 240. In this case the inlet 230 allows the mixture of gas and ink to flow directly into the bed of pieces of material 200. The bed of pieces of material 200 in itself effectively acts as an obstruction between the inlet 230 and the gas outlet that forces the flow of gas and ink to pass through (at least some of) the bed of pieces of material 200. In the particular embodiment of the separator illustrated in FIG. 6, the bed of pieces of material 200 fills the chamber 210 to a level that is below the gas outlet 240. This may be done so as to avoid the drainage of ink that has separated out on to the surfaces of the pieces of material though the gas outlet 240. In other embodiments, as will be described with reference to FIG. 7, the level of the bed of material 200 may be at a higher level relative to the gas outlet 240.

The individual pieces of material that make up the bed 200 can be chosen to be large enough so that they do not have a tendency to block the gas outlet 240. Similarly, the individual pieces of material can be chosen to be heavy enough so that they will not become entrained in the flow of gas exiting the chamber 210 via the gas outlet 240.

In the embodiment of the separator 10 illustrated in FIG. 7 a cage, mesh, filter 260 or similar is placed around or over the gas outlet 240 in the chamber 210 to prevent the pieces of material that make up the bed 200 from exiting the gas outlet 240. In this case it is not necessary to specify the size and weight of individual pieces of material that make up the bed 200 (at least with regard to avoiding the pieces of material from flowing through or blocking the gas outlet 240).

In the separator 20 shown in FIG. 7 the bed of pieces of material 200 substantially fills the chamber 210. A cage, mesh, filter 260 or similar may be placed around or over the gas outlet 240 to prevent or restrict ink from being drawn from the bed of pieces of material 200 into the gas exiting the gas outlet 240. The inlet 230 in this embodiment is arranged so that the flow of gas and ink is taken to the bottom portion of the bed of pieces of material 200. Also, the inlet 230 may generally be on the opposite side of the chamber 210 to the gas outlet 240. Such an arrangement extends the route that the flow of gas and ink takes through the bed of pieces of material 200.

By extending the route of the flow of gas and air through the separator 20 the efficiency of the separator 20 is improved. In some situations the route of the flow through the bed of pieces of material 200 is sufficiently long that effectively all of the ink (or enough of the ink) has been removed from the flow such that the portion of the bed of pieces of material surrounding, or in the neighborhood of, the gas outlet 240 does not contain any significant amounts of ink. In this situation there may not be a need for the cage, mesh, filter 260 or similar to be placed around or over the gas outlet 240 since a significant amount of ink will not drain or otherwise pass into the gas outlet 260 from the surrounding pieces of material.

FIG. 8 illustrates an embodiment of the separator 20 that has a chamber 210 in the form of a U-shaped container or tube. The tube has a geometry such that the bore (i.e. the diameter or other cross-section dimension) of the tube is smaller than height or the length of the tube. This arrangement provides a long path through the bed of pieces of material 200 compared to the volume of the bed 200/chamber 210 previously described. That is, a higher proportion of the pieces of material that make up the bed 200 can act to separate ink from the flow of gas and ink passing through the chamber 210. Although, commonly, the cross-section of the tube may be circular the cross section of the tube may take any shape. In some embodiments the shape and/or the size of the cross-section of the tube may vary along the tube's length.

A separator could be considered in which a number of U tube sections (similar to the separator 20 illustrated in FIG. 8) are formed to make a serpentine shape. In this case ink could be collected from the bottom of each of the U-shapes forming the separator 20. Referring to FIG. 9a a separator 20 is shown having a plurality of internal walls 220. The walls 220 force the flow of gas and ink to take a convoluted path through the bed of pieces of material 200, for example the gas and ink may take a substantially serpentine path through the bed of pieces of material 200. In this way more of the pieces of material that form the bed 200 can act to separate ink from the flow of the gas and ink. That is a separator 210 having a bed of pieces of material 200 can be made more efficient using internal walls 220 than a separator 20 having a bed of pieces of material 200 of the same volume but without internal walls. In this way the volume of the separator 20 can be reduced whilst maintaining the same cleaning efficiency. In some embodiments the internal walls 220 of the separator 20 are substantially vertical whilst in other embodiments the internal walls 220 are at a significant angle to vertical. Several wall configurations can be envisaged that achieve the purpose of directing the flow of gas and ink through a longer route through the bed of pieces of material 200 than if the flow gas and ink was otherwise unrestricted from flowing from the inlet 230 to the gas outlet 240. In some configurations, for example, the walls could be curved.

Blocks or similar obstructions may be placed in the separator 20. The surfaces/walls of such blocks/obstructions can act to direct the route of the flow of gas and ink through the bed of pieces of material 200. An embodiment of an isolator 20 containing block like obstructions is illustrated in FIG. 9b. Similarly, FIG. 9c illustrates an example of an isolator 20 that has block like obstructions that are formed from the inside wall of the isolator chamber 210. It will be appreciated that obstructions having geometries and configurations other than those illustrated may be used to divert/direct the flow of gas and ink through the isolator chamber 210.

Referring to FIG. 10, according to an embodiment of the invention, the separator 20 may be housed in a printer 100. The printer 100 has one or more printheads 10 for applying ink to a print medium or substrate. Periodically, the printheads 10 are cleaned by, for example, applying a vacuum to the printheads 10. The vacuum may be generated by a gas pump 30 and the vacuum applied to printhead 10 via a head having an opening such as a slit. Such a head is sometimes referred to as a “suction station” in the printing arts. Generally the printheads 10 will be surrounded by air so that when the vacuum is applied to the printheads 10 the vacuum acts to pull a flow of air and ink.

According to an embodiment of the invention, the separator 20 is placed in fluid communication with both the suction station 15 and the gas pump 30 so that the separator 20 can act to remove ink from the flow of air and ink before the flow enters the gas pump 30. In this way the flow of air is cleaned of ink before the flow enters the gas pump 40. The use of the separator 20 in this way helps to prevent the vacuum being compromised by the ink, protects the gas pump 30 from ink and provides cleaned air that can be more safely vented to the atmosphere.

Embodiments of the invention are not restricted to the use of a flow of air to transport ink away from the printheads 10 and other gases could be used (for example nitrogen).

The separator 20 may be provided with an ink outlet 250 so that ink can be removed from the separator 20. An ink pump 40 is shown attached to the ink outlet 250 to pull the ink from the separator 20, however in some embodiments ink is removed from the separator 20 by drainage under gravity alone and an ink pump is not used. In other embodiments ink could first be removed from the separator 20 under gravity alone (for example the ink outlet 250 could be open to allow ink to drain out of the separator chamber 210 substantially continuously, the majority of the time or for extended periods of time) then, after this drainage period, ink remaining in the chamber 210 could be pumped out of the chamber 220.

The ink removed from the chamber 210 may be held in an ink receptacle 50. The ink receptacle 50 may be housed in the printer 100, for example removably housed in the printer 100, or it may be outside of the printer 100 (as indicated by dashed line 112 in FIG. 10).

Referring to FIG. 11, according to an embodiment of the invention, a cleaning or service station 110 comprising the separator 20 is provided for connection to the printer 100 as required. The cleaning/service station 110 may comprise other components such as the gas pump 30 and/or the ink pump 40. In some embodiments the suction station 15 is part of the cleaning station 110, as illustrated in FIG. 11, whilst in other embodiments the suction station 15 is housed in the printer 100. A receptacle 50 for receiving ink may also be provided as part of the cleaning/service station 110 or it may be provided separately from the cleaning/service station 110 (as indicated by dashed line 112 in FIG. 11).

The cleaning/service station 110 may be used by connecting the cleaning/service station 110 to the printer 100 so as to clean the printheads 10 of that printer 100. One cleaning/service station 110 could be used to clean a plurality of printers 110 by connecting the cleaning/service station 110 to different printers 100 sequentially. Alternatively, one or more cleaning/service stations 110 could be simultaneously connected to a plurality of printers 100, for example by providing a cleaning station 110 with a plurality of suction stations 15. In another embodiment the printhead(s) 10 may be removed from a printer 100 and then connected/attached to a cleaning/service station 110 (either sequentially or simultaneously).

FIG. 12 illustrates a purging system 300 according to an embodiment of the invention. The purging system 300 comprises a source of pressure 80 connected to an ink container 70. When activated the source of pressure 80 forces ink from the ink container 70 through a printhead 10. The pressurized ink acts to push debris such as old ink and lint from the printhead 10. The ink and debris ejected from the printhead 10 is collected by a suction station 15 and passed through a separator 20 as previously described. In this embodiment a flow of gas and ink is passed into the separator 20 from a combination of pressure applied through the printhead 10 and a vacuum applied to the printhead 10 by the service station 15. It should be appreciated that a flow of gas and ink may be passed into the separator 20 by applying pressure alone through the printhead 10 or by applying a vacuum alone to the printhead 10.

In some embodiments a fluid other than ink, for example a solvent, may be passed through the printhead 10. In one example, solvent may first be passed through the printhead 10 followed by ink. In this case the solvent helps to dissolve residues on the printhead 10, such as ink residues, and the following ink removes traces of solvent from the printhead 10.

FIG. 13 is a flow diagram illustrating the operation of a separator 20 according to various embodiment of the invention. Not all the steps illustrated in the flow diagram are required for all embodiments of the invention. At step S110 a mixture of gas and ink is collected and passed into the separator 20. At step S120 ink is separated from the gas and ink in the separator 20. At step S130 gas is removed from the separator 20. The collection of step S110, step S120 and step S130 may be referred to as a “cleaning routine” S100. Such a cleaning routine S100 may be performed on demand, for example by a user pressing a button on a printer 100 or cleaning/service station 110 or by otherwise activating the cleaning routine S100 eg via an input device (mouse, keyboard, screen etc) on a computer or electronic system in communication with the printer 100 or cleaning/service station 110. The cleaning routine S100 may also be performed automatically in response to a set number of print jobs being performed, or a set amount of time (eg hourly, daily, weekly or whatever is appropriate for the printer 100 usage), a set amount of print output (e.g. number of characters, lines or pages of printed output), or a set print usage in terms of time (eg by monitoring the amount of time the printheads have been active for) or the amount of ink that has been used by the printer 100 since the last cleaning routine S100 was performed for that printer 100 or printhead 10.

An ink removal step S140 may be employed to remove ink from the separator 20. The ink removal step S140 may be performed as part of the cleaning routine S100, for example, the ink removal step S140 may be performed every time gas and ink are flowed into the separator 20 and separated. Alternatively, the ink removal step S140 may be performed periodically (eg hourly, daily, weekly or whatever is appropriate according to the usage of the printer 100 and/or the size of the separator chamber 210) either in an automatic or a manual step. The ink removal step S140 may be activated (either automatically or manually) when the ink reaches a particular level in the separator chamber 210.

Generally the volumetric flow rate of the gas pump 30 is much larger than the volumetric flow rate of the ink pump 40 (for example by 2,3, or 4 or more orders of magnitude). In one example the volumetric flow rate of the gas pump 30 is a few hundred litres/second (say 100-150 litres/second for illustration purposes) and volumetric flow rate of the ink pump 40 is a few tens of millilitres/second (say 20-30 millilitres/second for illustration purposes). The gas pump 30 and the ink pump 40 can be operated either simultaneously or at different times.

FIG. 14 is a flow diagram illustrating a process that may be used to produce a printed product according to various embodiments of the invention. Not all the steps illustrated in the flow diagram are required for all embodiments of the invention. The printed product may be, for example, one or more sheets of material, or a roll of material to which print has been applied. Commonly the material is paper or card but it could be any material or substrate that can support print eg fabric, acetate or other polymeric material. The product may be, for example, a book, leaflet or poster or a larger scale product such as would form, for example, an advertising hoarding, banner, or piece of art.

At step S210 a purge of the printhead 10 is performed. The purge step S210 may follow a printing step S200 or it may be performed, either automatically or by human activation, when the printer 100 is switched on or placed online (for example as part of an initialisation routine that is performed by the printer 100). As previously discussed the purge step S210 may involve forcing fluid through the printhead 10. Following or during the purge step S210 the cleaning routine S100 (as has been described with reference to FIG. 13) is performed to remove ink from the gas and ink flow produced by the purge step S210. For the purposes of this specification the combination of the purge step S210 and the cleaning routine S100 is termed a “purge routine” S300.

Following the purge routine S300 a print step S220 is performed. At step S230 printing is halted and at step S240 instructions are provided for the printhead 10 to be purged S210 or purging S210 is otherwise initiated (eg by manual/mechanical activation). The processing then continues with the cleaning routine S100 and the printer 100 may resume printing S220.

At step 230 the printing may be halted because the printer 100 has finished its current print job and/or the printhead 10 is scheduled to be purged. In one example the printing step S220 may correspond to producing a printed product and each time the process cycles through the flow diagram illustrated in FIG. 13 printing step S220 produces a different printed product. In another example the printing step S220 may correspond to the production of a plurality of printed products and each time the process cycles through the flow diagram of FIG. 13. In another situation the step S230 corresponds to pausing a print job so that the printhead 10 may be cleaned (for example a purge routine 300 may be performed). In this case two or more cycles of the process illustrated in FIG. 3 may be performed in order to produce a printed product. Steps S230 and S240 may be performed automatically or a user may activate the steps, for example the user may monitor the quality of the printed product being produced at step S220 and perform step S240 to initiate the purge routine S300 if the user judges that the print quality has deteriorated. In another example the quality of the printed product is assessed using an automated process, for example a process that involves optical character recognition or an associated technique.

It should be appreciated that in embodiments of the invention a solvent or other liquid is present/entrained in the flow of gas entering the separator 20 either instead of or as well as ink. For example a printhead 10 may be purged with a liquid solvent. The separator 20 then acts to separate the liquid solvent from the flow of gas and solvent entering the separator chamber 210 in the same way as has been described for the separation of ink from a flow of gas and ink.

In some embodiments a separator according to this invention occupies significantly less volume than commercially available separator tanks—for example about 0.5 times the volume of commercially available separator tanks. In some embodiments a separator according to this invention requires little or no maintenance (e.g. cleaning or periodic filter replacement).

Although embodiments of the invention have been described in detail, those skilled in the art will understand that various changes, substitutions, variations and improvements of those embodiments of the invention can be disclosed herein may be made without departing from the spirit and scope of the invention in its broadest form.

We claim:

1. A separator for separating ink from a flow of gas and ink, the separator comprising a chamber containing a plurality of material bodies, the chamber having:
an inlet for flowing a mixture of gas and ink into the chamber so that the gas and ink passes through interstices between at least some of the plurality of material bodies thereby separating ink from the mixture of gas and ink; and
a gas outlet for removing gas from the chamber after ink has been separated from the mixture of gas and ink.

2. The separator of claim 1 comprising an ink outlet for removing the separated ink from the chamber.

3. The separator of claim 2 wherein the ink outlet is lower than the gas outlet.

4. The separator of claim 1 wherein the chamber contains an absorber to absorb ink.

5. The separator of claim 1 wherein the chamber contains one or more internal barriers to direct the route of the flow of gas and air through the plurality of material bodies.

6. The separator of claim 5 wherein the one or more internal barriers comprise one or more internal walls.

7. A printer comprising at least one printhead, a pressure source for providing a flow of purging liquid through the printhead and a separator for separating purging liquid from a flow of gas and purging liquid, the separator comprising:
a chamber containing a bed of pieces of material;
an inlet for the flow of gas and purging liquid to enter the chamber so that the flow passes through the bed of pieces of material; and
a gas outlet for removing gas from the chamber after the mixture of gas and purging liquid has passed through the bed of pieces of material.

8. The printer of claim 7 comprising a purging liquid outlet for removing purging liquid from the chamber after the mixture of gas and purging liquid has passed through the bed of pieces of material, the purging liquid outlet being lower than the gas inlet.

9. The printer of claim 7 wherein the purging liquid is one of: i) ink; ii) solvent; and iii) a combination of ink and solvent.

10. A service station for cleaning a printhead comprising the separator of claim 1 and a gas pump in fluid connection with the gas outlet of the separator for removing gas from the chamber.

11. The service station of claim 10 comprising a pressure source for providing a flow of ink through the printhead for cleaning the printhead.

12. The service station of claim 10 wherein the separator comprises an ink outlet and the service station comprises an ink pump in fluid connection with the ink outlet for removing ink from the chamber.

13. A method of cleaning ink conduits comprising:
purging ink from the ink conduits to produce a flow of gas and ink;
passing the flow of gas and ink into a container containing a bed of material bodies so that the flow encounters the bed of material bodies; and
passing the gas out of the chamber after the gas has been passed through the bed of material bodies.

14. The method of claim 13, wherein said passing the gas out of the chamber comprises applying a vacuum to the container.

15. The method of claim 13, comprising draining ink from the container.

16. The method of claim 13 wherein said chamber has an ink outlet and said removing ink from the bed of material bodies comprises applying a vacuum to the ink outlet.

17. The method of claim 13 wherein when the flow of gas and ink encounters the bed of material bodies the ink wets the surface of at least some of the material bodies, thereby removing ink from the flow of gas and ink as the flow passes through the bed.

18. A process of producing a printed product comprising cleaning the printhead of a printer by performing a purge routine and then printing on a product using the printer, wherein the purge routine comprises:
purging ink from the printhead in the printer to produce a flow of gas and ink; passing the flow of gas and ink into a container containing a bed of material bodies so that the flow encounters the bed of material bodies; and
passing the gas out of the container after the gas has been passed through the bed of material bodies.

19. The process of claim 18 comprising printing on a first product with the printer, cleaning the printhead of the printer by performing said purging routine then printing on a second product once the cleaning routine has been performed.

20. The process of claim 18 wherein the second product is the first product.
